(19) United States
(12) Patent Application Publication
(10) Pub. No.: US 2017/0309385 A1
(43) Pub. Date: Oct. 26, 2017

(54) MAGNETIC ACTUATOR

(71) Applicant: RB Distribution, Inc., Colmar, PA (US)

(72) Inventors: Tam Van NGUYEN, Philadelphia, PA (US); David CIMBOLO, Phoenixville, PA (US)

(73) Assignee: RB Distribution, Inc., Colmar, PA (US)

(21) Appl. No.: 15/179,322

(22) Filed: Jun. 10, 2016

Related U.S. Application Data
(63) Continuation of application No. 29/561,991, filed on Apr. 21, 2016, now Pat. No. D793970.

(51) Int. Cl. H01F 7/16; F01L 1/34; F01L 9/04

(52) U.S. Cl. CPC H01F 7/16; F01L 9/04; F01L 1/34; F01L 2009/0478

(57) ABSTRACT

A magnetic actuator or liner actuator with improved plunger control and a simplified construction technique is provided.

This application claims the benefit of Application Serial No. 29.561,991 that was filed on Apr. 21, 2016 and is incorporated herein by reference as if fully set forth.

### FIELD OF INVENTION

This invention generally relates to phase adjusting a camshaft phaser to vary the timing of valve actuation by the camshaft. More particularly, this invention relates to magnetic actuation. Most particularly, this invention relates to a magnetic actuator having an improved construction that is believed to be more robust than prior magnetic actuators.

### BACKGROUND

It is known in the art relating to engine valve gear to provide various means for varying valve timing as desired for the control of engine performance and efficiency. There are various prior art mechanical devices for accomplishing the variable valve timing devices. See for example, U.S. Pat. Nos. 4,231,330 to Garcea; 4,811,698 to Akasaka et al; 5,163,872 to Niemiec et al; 6,155,220 to Marriott; and, 8,800,515 to Smith.

More recent devices use a magnetically actuated plunger that is akin to a liner actuator. Many of these prior art devices have wear or reliability issues that limit their useful life. The present invention concerns a magnetic device with an improved construction that addresses both prior art concerns.

### SUMMARY

The present invention addresses durability concerns associated with the prior devices. The magnetic actuator of the invention comprises a housing that enclosed the magnetic element and the associated plunger. The plunger has a central opening that holds a plunger rod that is substantially equal in length to the height of the housing. In addition to the plunger rod, the plunger has a lower opening that surrounds the lower end of the rod. The plunger, at rest, sits in a lower cup that has an outer portion surrounding the plunger body and an inner portion that fits within the lower opening. The plunger is stabilized by upper and lower bearings that surround the plunger rod and stabilize the plunger as it is activated by the magnetic field.

### BRIEF DESCRIPTION OF THE DRAWING(S)

FIG. 1 is a sectional view of a known prior art magnetic actuator;

FIG. 2 is a top orthographic view of the magnetic actuator according to the current invention;

FIG. 3 is a bottom orthographic view of the magnetic actuator according to the current invention;

FIG. 4 is an exploded view of the magnetic actuator according to the current invention;

FIG. 5 is a sectional view of the magnetic actuator according to the current invention; and,

FIG. 6 is an enlarged sectional view of the plunger and plunger rod combination of the present invention in an at-rest position within the base of the present invention.

### DETAILED DESCRIPTION OF THE PREFERRED EMBODIMENT(S)

As used herein to describe the drawing figures, terms like upper and lower are with reference to the drawings and used for convenience in describing the invention; they do not indicate or require and any specific orientation of the actuator in use.

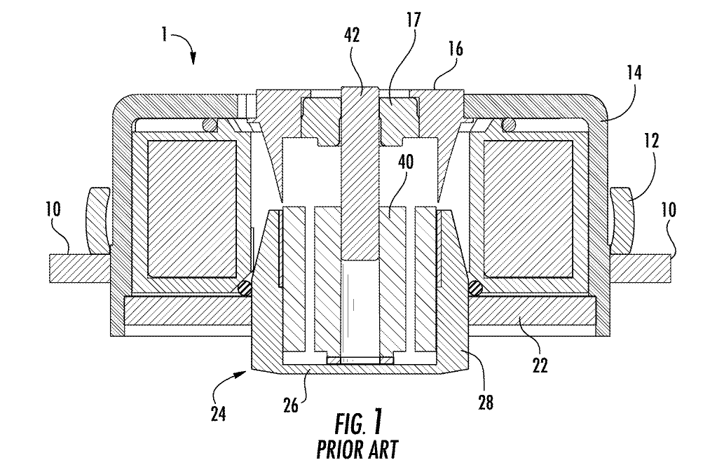

FIG. 1 illustrates a prior art magnetic actuator. In this configuration, the actuator 1 has a base 10, a gasket 12 and a case 14 that are standardized according to the application where the actuator is applied. The case 12 includes a coil 15 for actuating the plunger 40 and plunger rod 42. The application of electrical energy to the coil results in the creation of a field effect that acts on the plunger. The upper portion of case 14 is closed by the cap 16 and bearing 17; the lower portion is closed by the cover plate 22 and base 24, which is supported by the cover plate. The bearing 17 has a center aperture that surrounds and supports the plunger rod 42. The plunger rod 42 is connected to approximately the upper one-third of a plunger 40 that fits within the base 24. As shown in FIG. 1, plunger 40 has a central cap 43 that is resting on the floor 26 to create a gap 52 between the plunger 40 and the floor 26. The gap 52 communicates with the tubular openings 50 to form a relief path for any fluid that collects in the actuator. Since the plunger 40 substantially fills the base cavity defined by the surrounding wall 28, downward moving of the plunger will expel fluid from the base. This relief system serves to limit fluid pressure that may impede the movement of plunger 40. The upper portion of surrounding wall 28 includes the bearing surface 29 against which the plunger 40 rides.

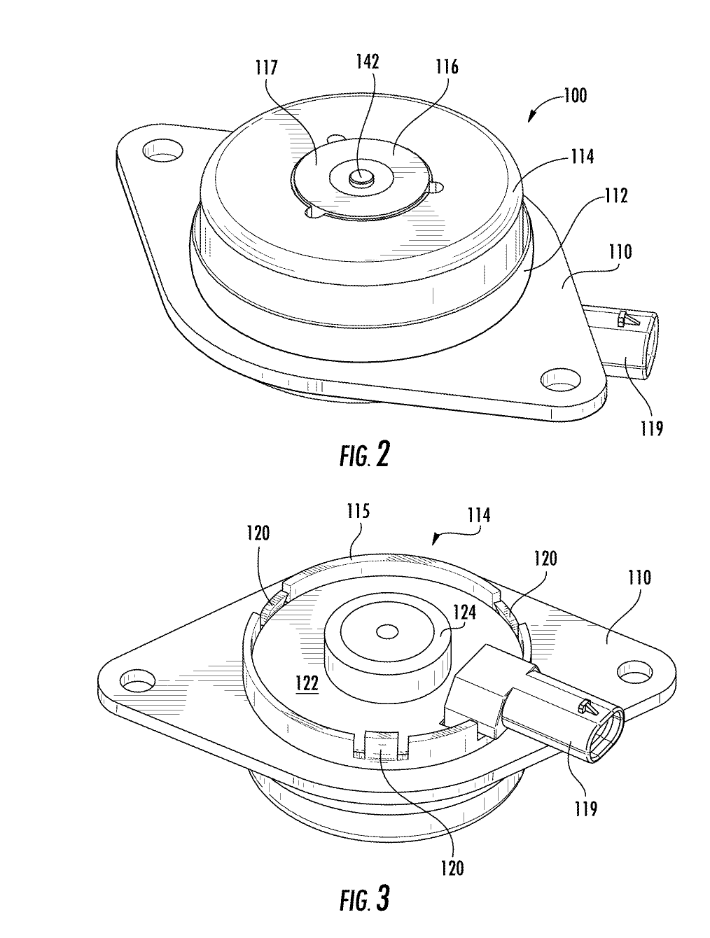

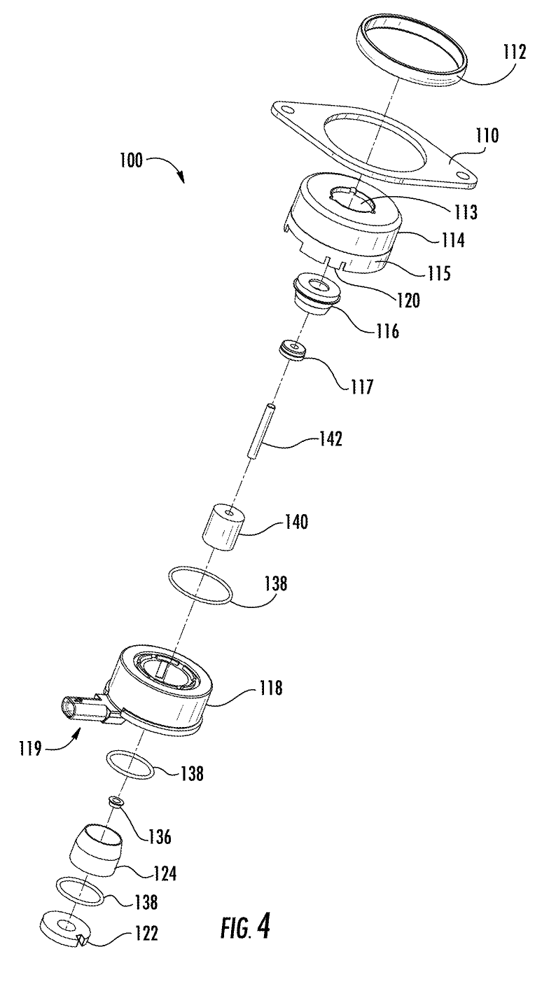

The construction of the present invention is described below in detail with reference to FIGS. 2-6. The size and external construction of the present invention is such that it is a direct replacement for prior art devices. The general exterior of the present invention can be seen from FIGS. 2 and 3. The actuator 100 has a mounting bracket 110, a gasket 112 and a case 114. In FIG. 2, the upper portion of the case 114 is shown to illustrate the cap 116, the bearing 117 and plunger 142. In FIG. 3, the lower portion or skirt of the case 114 is shown with segments 115 that are interspersed with tabs 120. Preferably, the segments 115 are about equal in size and the tabs 120 are spaced accordingly. Bending the tabs 120 inwardly holds the plate 122 in place. This construction with tabs holding plate 122 in place is more forgiving than the prior art construction and is unique to this construction.

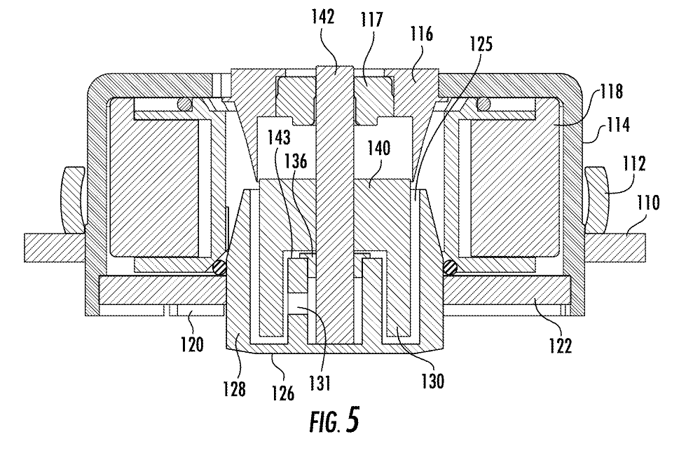

FIG. 4 is an exploded view of the component parts of the actuator 100. The mounting bracket 110 and gasket 112 fit about the housing 114; the aperture 113 in the upper surface of the housing 114 is closed by the cap 116 and bearing 117. The electrical core or magnetic element 118 and electrical connector 119 fit within the housing 114 with the O-rings 138 and cover plate 122. These components of the internal construction are common with the prior art. The remaining elements: tabs 120; base 124; bearing 136; plunger 140; and plunger rod 142 are unique to the present construction.

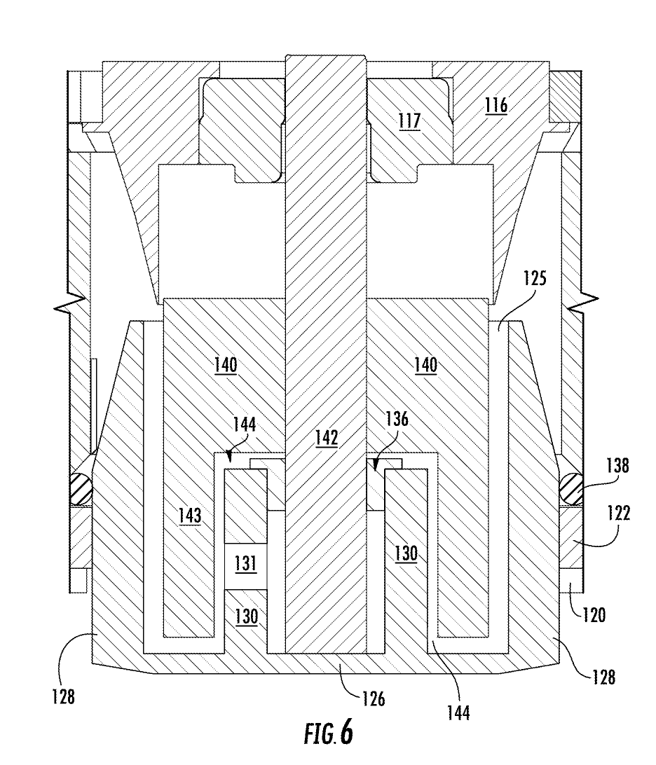

With reference to the sectional views of the invention in FIGS. 5 and 6, the preferred construction can be described in detail. The base 124 fits within the lower plate 122 and closes the lower aperture, which is on centerline with the aperture 113 in the upper surface of housing 114. The base 124 is generally tubular with an open end 125, a floor 126, an exterior wall 128, and an interior wall 130. The height of the exterior wall 128 is determined by the height of the plunger 140, and the plunder height is determined by the electrical, coil 15, and mass requirements of the actuator. The interior wall 130 is spaced from the exterior wall 128 to define a gap 132 between the two walls. The height of interior wall is selected to accommodate the plunger 140 as is explained hereinafter; however, the height of the interior wall 130 is less than the height of exterior wall 130 and is typically about half the height of exterior wall 128.

Since with reference to FIGS. 5 and 6, interior wall 130 has a relief aperture 131, which is circular in this embodiment. The relief aperture 131 provides an outlet for any fluid that collects in the base 124. The plunger 140 urges fluid through the aperture 131 and into the gap 132 between the interior and exterior walls 130 and 128 so the fluid does not create backpressure on the plunger 140. A brass bearing 136 is located on the top of interior wall 130 and on centerline with the bearing 117 in the upper surface of the housing 140. The bearings 117 and 136 stabilize the non-magnetic plunger rod 142, which, in this embodiment, has an extend length so it reaches from the upper surface aperture to the interior surface of the base floor 126. The lower end of the plunger rod 142 and the position of bearing 136 are selected so that the plunger rod 142 is never released from the bearing 136. This longer plunger rod 140 in combination with the bearing 117 and 136 provides a more stable travel path for the plunder and rod combination. This more stable travel path avoids prior art wear problems associated with a condition characterized as plunger wobble. The space between the top of plunger 140 and the bottom of bearing 117 is approximately 6 mm; the space between the bottom of the plunger 140 and floor 126 is approximately 0.5 mm; and, the space between the inside bottom 131(a) of the plunger 140 and the interior wall 130 is approximately 0.5 mm, which is the thickness of the brass bearing 136. These tolerances along with the non-magnetic plunger rod 142 provide an electrical isolation between the plunger 140 and the tubular base 124.

Still with reference to FIGS. 5 and 6, the plunger 140 has a lower portion 143 that defines an interior recess 144 that extends from the bottom 140(a) of the plunger 140 to an interior bottom 140(b) of plunger 140. The recess 144 fits over or receives the interior wall 130 so that the lower portion 143 fits or nest within the concentric circles formed by exterior wall 128 and interior wall 130. Because the bearing 136 is maintaining the plunger 140 on center with the bearing 117 in the upper surface, the vertical movement of the plunger 140 is closely controlled and the gaps or spaces between the components are retained in a nested relationship and the electrical requirements of the actuator are not adversely impacted by this construction.

Referring now to FIG. 3, a description of the improved actuator assembly is provided. According to this construction, the components identified in FIG. 4 are assembled in the housing 114 and the cover plate 122 closes the housing. The present assembly differs from prior assemblies in that lower portion or skirt 115 of housing 114 has a plurality of tabs 120. When the tabs are bent over the plate 122, they lock it in place. This construction technique is more tolerant of manufacturing differences and is a simplified approach to assembling the actuator.

What we claim is:

1. A linear actuator, comprising:
a housing that has an upper surface, a circumferential wall, and a cover that define an interior space, the upper surface and the cover have apertures on a common centerline, and the cover has a base that fits within and closes the aperture in the cover;
the base has a floor, a first wall of a predetermined height and a second wall that is interior to and spaced from the first wall and has a predetermined height that is less than the predetermined height of the first wall so there is open space between the first and second walls and open space that is above the second wall and within the first wall;
an electrical element that is positioned between the first wall of the base and the circumferential wall of the housing;
a plunger having an exterior configuration that fits within the space defined by the first and second walls of the base, an internal relief that receives the second wall of the base, and a central opening that receives a plunger rod; and,
a plunger rod that is connected to the plunger and has a height sufficient to extend from the floor of the base to an aperture in the upper surface of the housing;
whereby the electrical element controls movement of the plunger and the plunger rod and causes the plunge rod to extend outwardly and retract inwardly through the aperture in the upper surface of the housing.

2. An actuation element for a magnetic actuator having a housing that encloses an electrical element and upper and lower surfaces that have apertures on a common centerline, the actuation element comprising:
a base that fits within and closes the aperture in the lower surface and has a floor, a first wall of a predetermined height and a second wall that is interior to and spaced from the first wall and has a predetermined height that is less than the predetermined height of the first wall so there is open space between the first and second walls and open space that is above the second wall and within the first wall; and,
a plunger and a rod member wherein the plunger has an exterior configuration that fits within the space defined by the first and second walls and a central relief dimensioned to receive the second wall within the relief, and a plunger rod having a height sufficient to extend from the floor of the base to the aperture in the upper surface of the housing.

3. A linear actuator, comprising:
a housing that has a first member with a planar surface defining a central opening and a circumferential wall defining an open interior space, and a second member that joins the circumferential wall and closes the interior space, the second member has a central opening on a centerline with the central opening of the planar surface;
a magnet element that encircles the central opening;
a base that defines a lower interior surface for the housing and fits within and closes an aperture in the second member, the base has a first wall of a predetermined height and a second wall that is spaced from the first wall and has a smaller predetermined height than the first wall so there is open space between the first and second walls and open space that is above the second wall and within the first wall; and,
a plunger and a rod combination where the plunger has an exterior configuration that fits within the space defined by the first and second walls and a central relief configured to receive the second wall within the relief, and the rod has a height sufficient to extend from the lower interior surface of the base to the aperture in an upper surface of the housing.

4. A linear actuator, comprising:
a housing that has an upper surface, a circumferential wall, and a cover that define an interior space, the upper surface and the cover have apertures on a common centerline, and the cover has a base that fits within and closes the aperture in the cover;
the base has a floor, a first wall of a predetermined height and a second wall that is interior to and spaced from the first wall and has a predetermined height that is less than the predetermined height of the first wall so there is open space between the first and second walls and open space that is above the second wall and within the first wall;
an electrical element that is positioned between the first wall of the base and the circumferential wall of the housing and generates a current;
a plunger having a body with an exterior that fits within the first wall of the base and an interior relief that fits over the second wall of the base, and a plunger rod extending through the center of the plunger body;
the plunger rod having a height sufficient to extend from the floor of the base to an aperture in the upper surface of the housing, and moves outwardly and inwardly through the aperture in the upper surface of the housing in response to current generated by the electrical element.

5. The linear actuator of claim 4 wherein, the first and second wall of the base and the plunder body are tubular.

6. The linear actuator of claim 4 wherein, a bearing at the upper surface of the housing and a bearing mounted on the second wall of the base guide the movement of the plunger rod.

7. The linear actuator of claim 4 wherein, the cover is positioned within the circumferential wall of the housing and the circumferential wall of the housing has a plurality of dependent tabs that maintain the cover's position within the circumferential wall of the housing.

8. The linear actuator of claim 4 wherein, the plunger has a predetermined diameter that is less than a predetermined interior diameter of the second wall of the base and there is an interior void formed between them.

9. The linear actuator of claim 8 wherein, the second wall of the base has an aperture that extends between the interior void and the interior relief of the plunger body.

10. A linear actuator container for containing an electrical element, a plunger that is controlled by the electrical element and a plunger rod that guides the plunger movement within the container, the container comprising:
a housing with an upper surface and a dependent circumferential wall with a lower portion that includes a plurality of tabs, the circumferential wall has a predetermined height between the upper surface and the lower portion that includes the plurality of tabs; and a lower surface member that joins with the dependent circumferential wall, at the predetermined height to enclose an electrical element, a plunger and a plunger rod, and is locked in place by the plurality of tabs.
